(19) United States
(12) Patent Application Publication
(10) Pub. No.: US 2010/0014829 A1
(43) Pub. Date: Jan. 21, 2010

(54) INFORMATION REPRODUCING APPARATUS AND METHOD, AND COMPUTER PROGRAM

(75) Inventors: Takeshi Koda, Tokorozawa-shi (JP); Keiji Katata, Tokorozawa-shi (JP); Masayoshi Yoshida, Tokorozawa-shi (JP)

Correspondence Address: YOUNG & THOMPSON, 209 Madison Street, Suite 500, Alexandria, VA, 22314, US

(73) Assignee: Pioneer Corporation, Tokyo (JP)

(21) Appl. No.: 12/438,832

(22) PCT Filed: Aug. 29, 2006
(86) PCT No.: PCT/JP2006/316976

§ 371 Date: Mar. 19, 2009

(51) Int. Cl. H04N 5/91; H04N 7/26

(52) U.S. Cl. 386/82; 386/124

(57) ABSTRACT

An information reproducing apparatus (100) is for reproducing an information recording medium (10) on which each of first data according to a reproduction standard and second data according to a recording standard is recorded, and is provided with: a reproducing device (112, 130) for reproducing the first data or the second data; and a controlling device (129) for controlling the reproducing device such that the reproducing device starts the reproduction of the second data if the reproducing device reproduces the first data.

### TECHNICAL FIELD

The present invention relates to an information reproducing apparatus and method such as a DVD player, a BD player, and HD player, and a computer program which makes a computer function as such an information reproducing apparatus.

### BACKGROUND ART

The DVD-Video standard is complied with, in the case where video information compression-coded by MPEG (Moving Picture Expert Group) 1 or MPEG 2, which are one example of compression-coding, is recorded onto an optical disc such as a DVD. According to the DVD-Video standard, the compression-coding and high-density recording of the record data have advanced to the extent that content information with a volume of about one movie can be recorded on one optical disc. The DVD-Video standard is standardized mainly to prepare packaged software including a title such as a movie, and to sell the packaged software to users. That is, the DVD-Video standard is set as a so-called ROM (in other words, reproduction) standard. On the other hand, since the DVD-Video standard is standardized mainly to record the read-only title, a user's arbitrary editing is restricted. In particular, the DVD-Video standard is not suited for such an application that a user records a title such as a TV program, in which commercial messages (CM) and a main story are discretely arranged, while editing the CM. Because of this, in the DVD-Video standard, a menu for selecting the title to be reproduced and a menu for selecting an aspect of reproducing the title (e.g. subtitles, audio, and the like) are prepared by considering only operations about the title(s) stored in the packaged software from the beginning. Thus, in the DVD-Video standard, the user's arbitrary editing is restricted, even regarding the menus.

That is why the DVD-VR (Video Recording) standard, disclosed in a patent document 1, is standardized in addition to the DVD-Video standard. In the DVD-VR standard, a user can record the title such as a TV program in which CM and a main story are discretely arranged, while editing the CM, or a user can edit it after recording the title. That is, the DVD-VR standard is set as a so-called recording (in other words, video recording) standard. Moreover, since the DVD-VR standard is the standard for recording which is designed for the editing by users, the menu can be also prepared, as occasion demands, on the user side or the information reproducing apparatus side. Patent document 1: Japanese Patent Application Publication NO. Hei 04-162261

### DISCLOSURE OF INVENTION

### Subject to be Solved by the Invention

By the way, there can be such an assumption that the title according to the DVD-Video standard and the title according to the DVD-VR standard are recorded on one optical disc. In this case, for example, if a menu that allows selection of which title is to be reproduced between the title according to the DVD-Video standard and the title according to the DVD-VR standard is prepared as the menu of the title according to the DVD-VR standard which can be uniquely prepared, it is possible to appropriately reproduce the title desired by a user, of the two titles, using the menu.

However, since the user's arbitrary editing about the menu of the title according to the DVD-Video standard is restricted, there is no concern about the presence of the title according to the DVD-R standard in the menu of the title according to the DVD-Video standard. That is, the menu for reproducing the title according to the DVD-VR standard, which is recorded by a user as occasion demands, is not considered in the menu of the title according to the DVD-Video standard. Thus, there can be such a technical problem that it is hardly possible to change to an operation of reproducing the title according to the DVD-VR standard once an operation of reproducing the title according to the DVD-Video standard is started.

In this case, if the optical disc is ejected from the information reproducing apparatus once (i.e. if the operations performed so far are completely reset), it is considered that the operation of reproducing the title according to the DVD-VR standard can be started even after the operation of reproducing the title according to the DVD-Video standard is started once. This method, however, forces users to perform an eject operation and a re-loading operation, and it can be hardly said that the method can be preferable.

The aforementioned technical problem may occur not only in the optical disc on which the title according to the DVD-Video standard and the title according to the DVD-VR standard are recorded but also in other optical discs. That is, the aforementioned technical problem likely occurs in an optical disc on which the title according to a certain standard (in particular, a reproduction standard in which the recording by users is not considered) and the title according to another certain standard (in particular, a recording standard which is used when the recording is performed by users) are recorded.

In view of the aforementioned problems, it is therefore an object of the present invention to provide an information reproducing apparatus and method, which allow appropriate reproduction of data according to the reproduction standard and data according to the recording standard even if the two data are recorded on one information recording medium, and a computer program which makes a computer function as such an information reproducing apparatus.

### Means for Solving the Subject

The above object of the present invention can be achieved by an information reproducing apparatus according to claim 1 for reproducing an information recording medium on which each of first data according to a reproduction standard and second data according to a recording standard is recorded, the information reproducing apparatus provided with: a reproducing device for reproducing the first data or the second data; and a controlling device for controlling the reproducing device such that the reproducing device starts the reproduction of the second data if the reproducing device reproduces the first data.

The above object of the present invention can be also achieved by an information reproducing method according to claim 13 of reproducing an information recording medium on which each of first data according to a reproduction format and second data according to a recording format is recorded, the information reproducing method provided with: a reproducing process of reproducing the first data or the second data; and a controlling process of controlling the reproducing device such that the reproducing device starts the reproduction of the second data if the reproducing device reproduces the first data.

The above object of the present invention can be also achieved by a computer program according to claim 14 for reproduction control and for controlling a computer provided for an information reproducing apparatus for reproducing an information recording medium on which each of first data to according to a reproduction standard and second data according to a recording standard is recorded, the information reproducing apparatus provided with: a reproducing device for reproducing the first data or the second data; and a controlling device for controlling the reproducing device such that the reproducing device starts the reproduction of the second data if the reproducing device reproduces the first data, the computer program making the computer function as at least one portion of the reproducing device and the controlling device.

These operation and other advantages of the present invention will become more apparent from the embodiments explained below.

### BRIEF DESCRIPTION OF DRAWINGS

FIG. 1 are a schematic plan view showing one basic structure of an optical disc in an example, and a schematic cross sectional view showing the optical disc and a schematic conceptual view showing a recording area structure in the radial direction associated with the cross sectional view.

FIG. 2 is a block diagram conceptually showing the basic structure of an information reproducing apparatus in the example.

FIG. 3 are plan views conceptually showing a menu screen for BDMV data and a menu screen for BDAV data.

FIG. 4 is a plan view conceptually showing the menu screen for BDMV data on which an additional button unique to the information reproducing apparatus is displayed.

FIG. 5 is a state transition diagram conceptually showing a transition aspect of a state of the information reproducing apparatus in the example.

FIG. 6 are plan views conceptually showing a first menu screen for BDMV data before and after the additional button is displayed.

FIG. 7 are plan views conceptually showing a transition relation when each of the buttons is selected on the first menu screen before and after the additional button is displayed.

FIG. 8 are plan views conceptually showing a second menu screen for BDMV data before and after the additional button is displayed.

FIG. 9 are plan views conceptually showing a transition relation when each of the buttons is selected on the second menu screen before and after the additional button is displayed.

FIG. 10 is a perspective view conceptually showing a remote controller provided for an information reproducing apparatus in a modified example.

### DESCRIPTION OF REFERENCE CODES

10 optical disc
100 information reproducing apparatus
112 optical pickup
113 signal recording device
121 CPU
128 button display device
129 operation control device
131 remote controller
132 state transition operation button
305 additional button

### BEST MODE FOR CARRYING OUT THE INVENTION

Hereinafter, as the best mode for carrying out the present invention, an explanation will be given on embodiments of the information reproducing apparatus and method, and the computer program of the present invention.

### Embodiment of Information Reproducing Apparatus

An embodiment of the information reproducing apparatus of the present invention is an information reproducing apparatus for reproducing an information recording medium on which each of first data according to a reproduction standard and second data according to a recording standard is recorded, the information reproducing apparatus provided with: a reproducing device for reproducing the first data or the second data; and a controlling device for controlling the reproducing device such that the reproducing device starts the reproduction of the second data if the reproducing device reproduces the first data.

According to the embodiment of the information reproducing apparatus of the present invention, the first data including video, audio, and the like is reproduced by the operation of the reproducing device. The first data complies with the reproduction standard (in other words, the standard used when the data is recorded onto a read-only recording medium). In the same manner, the second data including video, audio, and the like is reproduced by the operation of the reproducing device. The second data complies with the recording standard (in other words, the standard used when data is recorded onto a recordable recording medium). That is, the information reproducing apparatus in the embodiment can reproduce each of the first data and the second data recorded on one information recording medium.

In the embodiment, in particular, the operation of the reproducing device is controlled by the operation of the controlling device such that the reproducing device starts the reproduction of the second data if the reproducing device reproduces the first data. More specifically, the operation of the reproducing device is controlled by the operation of the controlling device such that the reproducing device starts the reproduction of the second data if various conditions described later are satisfied when the reproducing device reproduces the first data. That is, in the embodiment, the operation of the reproducing device is changed by the operation of the controlling device from the state that the first data is reproduced to the state that the second data is reproduced.

Here, since the first data according to the reproduction standard is generated by being authored in advance, the simultaneous recording of data other than the first data onto the information recording medium is not considered. Thus, once the reproduction of the first data is started, an operation other than the operation about the reproduction of the first data (e.g. an operation of reproducing the second data) is not provided. That is, the second data cannot be reproduced as long as the reproduction proceeds using the reproduction sequence of the first data or the like.

According to the embodiment, however, even after the reproduction of the first data according to the reproduction standard is started, the second a data according to the recording standard can be reproduced by the operation of the controlling device which is uniquely provided for the information reproducing apparatus. In particular, in order to start the reproduction of the second data after the reproduction of the first data is started, it is unnecessary to eject the information recording medium from the information reproducing apparatus to reset the operation of the information reproducing apparatus. That is, users can relatively easily change the operation of the reproducing device from the state that the first data is reproduced to the state that the second data is reproduced.

In addition, it is considered that the second data according to the recording standard is recorded (or written once) by a user as occasion demands. Thus, the second data can be recorded in consideration of the fact that the first data is recorded on the information recording medium. Therefore, it is possible to provide the second data with data (e.g. a menu described later) for changing the operation of the reproducing device from the state that the first data is reproduced to the state that the second data is reproduced. Thus, in the embodiment, it is possible to appropriately change the operation of the reproducing device from the state that the first data is reproduced to the state that the second data is reproduced, or from the state that the second data is reproduced to the state that the first data is reproduced.

Of course, if the reproduction of the first data is not started, the reproducing device can obviously reproduce the second data regardless of the operation of the controlling device. In short, the controlling device provided for the information reproducing apparatus in the embodiment has an excellent effect in that the reproduction of the second data can be started without causing a user to perform a troublesome or complicated operation after the reproduction of the first data is started.

As described above, according to the embodiment of the information reproducing apparatus of the present invention, even if both the first data according to the reproduction standard and the second data according to the recording standard are recorded on one information recording medium, it is possible to appropriately reproduce each of the first data and the second data.

In one aspect of the embodiment of the information reproducing apparatus of the present invention, the controlling device controls the reproducing device such that the reproducing device starts reproduction of a menu included in the second data (i.e. a menu for the second data) if the reproducing device reproduces the first data.

According to this aspect, even if both the first data according to the reproduction standard and the second data according to the recording standard are recorded on one information recording medium, it is possible to appropriately reproduce each of the first data and the second data.

In another aspect of the embodiment of the information reproducing apparatus of the present invention, the controlling device controls the reproducing device such that the reproducing device starts the reproduction of the second data if the reproducing device reproduces a menu included in the first data.

According to this aspect, even if both the first data according to the reproduction standard and the second data according to the recording standard are recorded on one information recording medium, it is possible to appropriately reproduce each of the first data and the second data.

In another aspect of the embodiment of the information reproducing apparatus of the present invention, it is further provided with a displaying device for displaying a unique button unique to the information reproducing apparatus with the unique button superimposed on the first data if the reproducing device reproduces the first data, the controlling device controlling the reproducing device such that the reproducing device starts the reproduction of the second data if the unique button is selected and activated when the reproducing device reproduces the first data.

According to this aspect, the unique button unique to the information reproducing apparatus (in other words, independent of the first data) is displayed, with the unique button superimposed on the first data, by the operation of the displaying device. For example, if the first data includes video, the unique button is displayed with it superimposed on the video. Then, the controlling device controls the reproducing device such that the reproducing device starts the reproduction of the second data if the unique button is selected and activated when the reproducing device reproduces the first data. This allows a user to visually recognize the unique button for changing the operation of the reproducing device and to change the operation of the reproducing device in the user's desired timing.

In an aspect of the information reproducing apparatus provided with the displaying device as described above, the displaying device may display the unique button with the unique button superimposed on a menu included in the first data.

By virtue of such construction, using the menu included in the first data, it is possible to perform the operation about the first data and to change the operation of the reproducing device.

In an aspect of the information reproducing apparatus provided with the displaying device as described above, the displaying device may display the unique button at a different position from a position at which a first data button included in the first data is displayed.

By virtue of such construction, the unique button and the first data button are no longer superimposed when displayed. That is, it is possible to display the unique button without an influence on the operation of the first data button included in the first data.

In an aspect of the information reproducing apparatus provided with the displaying device as described above, the displaying device may display the unique button such that a first data button included in the first data and the unique button are disposed in a substantially uniform manner.

By virtue of such construction, it is possible to display the unique button in balance with the first data button included in the first data. Incidentally, “the first data button and the unique button are disposed in a substantially uniform manner” indicates in effect that the unique button is disposed at a position which does not bring discomfort to the existing first data button.

In an aspect of the information reproducing apparatus provided with the displaying device as described above, the displaying device may display the unique button having a size corresponding to a first data button included in the first data.

By virtue of such construction, it is possible to display the unique button in balance with the first data button included in the first data.

In an aspect of the information reproducing apparatus provided with the displaying device as described above, the displaying device may display the unique button while adding a transition relation when selecting each of the unique button and the first data button included in the first data to a transition relation when selecting a first data button included in the first data.

By virtue of such construction, it is possible to select the unique button in the same manner as the operation of selecting the first data button. This allows consistency between the unique button unique to the information reproducing apparatus (in other words, independent of the first data) and the first data button.

In an aspect of the information reproducing apparatus provided with the displaying device as described above, the displaying device displays the unique button after a certain time has elapsed since the reproducing device started the reproduction of the first data.

By virtue of such construction, the first data in which the unique button is not displayed (i.e. the original first data) is reproduced for the certain time. Therefore, it is possible to prevent the possibility that the unique button is unintentionally superimposed on video included in the first data (in particular, meaningful or important video) and thus a user cannot watch video at all. That is, a user can watch the video at least for the certain time.

In another aspect of the embodiment of the information reproducing apparatus of the present invention, it is further provided with an inputting device for giving the controlling device an input instruction to control the reproducing device such that the reproducing device starts the reproduction of the second data, the controlling device controlling the reproducing device such that the reproducing device starts the reproduction of the second data if the input instruction is given by the inputting device when the reproducing device reproduces the first data.

According to this aspect, using the inputting device such as a remote controller, it is possible to change the operation of the reproducing device by that a user gives the input instruction.

In another aspect of the embodiment of the information reproducing apparatus of the present invention, the controlling device controls the reproducing device such that the reproducing device starts the reproduction of the second data after a certain time has elapsed since the reproducing device started the reproduction of the first data.

According to this aspect, it is possible to change the operation of the reproducing device without through the user's manipulation.

In another aspect of the embodiment of the information reproducing apparatus of the present invention, the reproduction standard includes at least one of a DVD-Video standard, a BD-Video standard, and an HD DVD-Video standard, and the recording standard includes at least one of a DVD-VR standard, a BD-VR standard, and a HD DVD-VR standard.

According to this aspect, it is possible to receive the aforementioned various benefits in the aforementioned known various standards.

### Embodiment of Information Reproducing Method

An embodiment of the information reproducing method of the present invention is an information reproducing method of reproducing an information recording medium on which each of first data according to a reproduction format and second data according to a recording format is recorded, the information reproducing method provided with: a reproducing process of reproducing the first data or the second data; and a controlling process of controlling the reproducing device such that the reproducing device starts the reproduction of the second data if the reproducing device reproduces the first data.

According to the embodiment of the information reproducing method of the present invention, it is possible to receive the same various benefits as those in the embodiment of the information reproducing apparatus of the present invention.

Incidentally, in response to the various aspects in the embodiment of the information reproducing apparatus of the present invention, the embodiment of the information reproducing method of the present invention can also employ various aspects.

### Embodiment of Computer Program

An embodiment of the computer program of the present invention is a computer program for reproduction control and for controlling a computer provided for an information reproducing apparatus for reproducing an information recording medium on which each of first data according to a reproduction standard and second data according to a recording standard is recorded, the information reproducing apparatus provided with: a reproducing device for reproducing the first data or the second data; and a controlling device for controlling the reproducing device such that the reproducing device starts the reproduction of the second data if the reproducing device reproduces the first data (i.e. the aforementioned embodiment of the information reproducing apparatus of the present invention (including its various aspects)), the computer program making the computer function as at least one portion of the reproducing device and the controlling device.

According to the computer program of the present invention, the embodiment of the information reproducing apparatus of the present invention described above can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the embodiment of the information reproducing apparatus of the present invention, the embodiment of the computer program of the present invention can also employ various aspects.

The above object of the present invention can be also achieved by a computer program product in a computer-readable medium for tangibly embodying a program of instructions executable by a computer provided in an information reproducing apparatus for reproducing an information recording medium on which each of first data according to a reproduction standard and second data according to a recording standard is recorded, the information reproducing apparatus provided with: a reproducing device for reproducing the first data or the second data; and a controlling device for controlling the reproducing device such that the reproducing device starts the reproduction of the second data if the reproducing device reproduces the first data (i.e. the aforementioned embodiment of the information reproducing apparatus of the present invention (including its various aspects)), the computer program product making the computer function as at least one portion of the reproducing device and the controlling device.

According to the embodiment of the computer program product of the present invention, the embodiment of the information reproducing apparatus of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the embodiment of the information reproducing apparatus of the present invention described above.

Incidentally, in response to the various aspects in the embodiment of the information reproducing apparatus of the present invention described above, the embodiment of the computer program product of the present invention can also employ various aspects.

These operation and other advantages of the embodiments will become more apparent from the example explained below.

As explained above, according to the embodiment of the information reproducing apparatus of the present invention, it is provided with the reproducing device and the controlling device. According to the embodiment of the information reproducing method of the present invention, it is provided with the reproducing process and the controlling process. According to the embodiment of the computer program of the present invention, it makes a computer function as the reproducing device and the controlling device. Therefore, even if both the data according to the reproduction standard and the data according to the recording standard are recorded on one information recording medium, it is possible to appropriately reproduce the both data.

### Example

Hereinafter. an example of the present invention will be explained with reference to the drawings.

### (1) Information Recording Medium

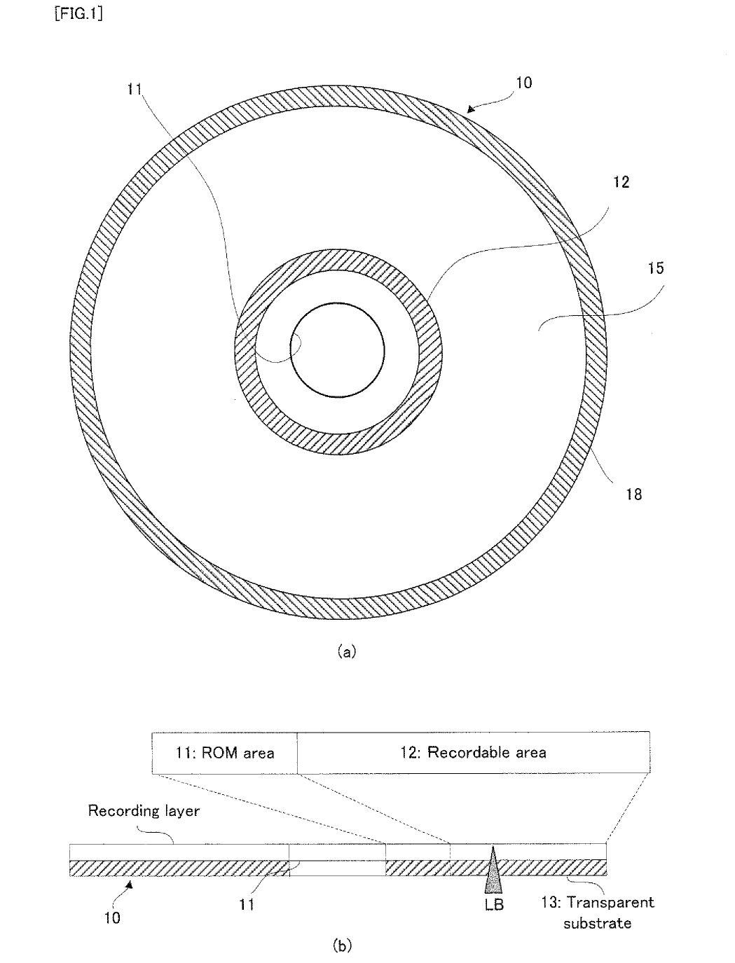

Firstly, with reference to FIG. 1, an explanation will be given on an optical disc as an example of the information recording medium of the present invention. FIG. 1(a) is a schematic plan view showing one basic structure of the optical disc in the example, and FIG. 1(b) is a schematic cross sectional view showing the optical disc and a schematic conceptual view showing a recording area structure in the radial direction associated with the cross sectional view.

As shown in FIG. 1(a) and FIG. 1(b), an optical disc 10 in the example has a recording surface on a disc main body with a diameter of about 12 cm, as in a DVD, for example. The optical disc 10 has a recording layer or the like laminated on a transparent substrate 13. In each recording area of the recording layer, tracks such as a groove track and a land track are alternately provided, spirally or concentrically, centered on the center hole 11. Moreover, on the tracks, data is divided and recorded by a unit of ECC block. The ECC block is a data management unit by which the data can be error-corrected.

In the example, in particular, as shown in FIG. 1(b), the optical disc 10 has the center hole 11 as the center, a read-only ROM area 11 disposed on the inner circumferential side, and a recordable area 12 disposed on the outer circumferential side of the ROM area 11.

The ROM area 11 is a read-only recording area in which a user cannot record any data. In the ROM area 11, BDMV data is recorded, wherein the BDMV data constitutes one specific example of the “first data” of the present invention and is complies with the Video standard of a BD (Blu-ray)-ROM which constitutes one specific example of the “reproduction standard” of the present invention. The BDMV data is data such as a movie authorized in advance by an author.

The recordable area 12 is a recording area in which a user can record data. In the recordable area 12, BDAV data is recorded, wherein the BDAV data constitutes one specific example of the “second data” of the present invention and is complies with the BD-VR (Video Recording) standard which constitutes one specific example of the “recording standard” of the present invention. The BDAV data is, for example, various TV programs and the like recorded by users.

Incidentally, the data according to the DVD-Video standard, which constitutes one specific example of the “reproduction standard” of the present invention, may be recorded in the ROM area 11, and the data according to the DVD-VR standard, which constitutes one specific example of the “recording standard” of the present invention, may be recorded in the recordable area 12.

Moreover, the optical disc 10 in the example is not limited to the optical disc provided with the single recording layer as shown in FIG. 1(a) and FIG. 1(b), but may be an optical disc provided with a plurality of recording layers. For example, one entire recording layer of the plurality of recording layers may be the ROM area 11, and another entire recording layer of the plurality of recording layers may be the recording area 12. Alternatively, for example, one portion of one recording layer and one portion of another recording layer of the plurality of recording layers may be the ROM area 11, and another portion of the one recording layer and another portion of the another recording layer of the plurality of recording layers may be the recordable area 12.

Moreover, the optical disc 10 is not necessarily provided with both the ROM area 11 and the recordable area 12. For example, the optical disc 10 may be provided only with the ROM area 11. In this case, each of the BDMV data and the BDAV data is recorded in the ROM area 11. Alternatively, the optical disc 10 may be provided only with the recordable area 12. In this case, each of the BDMV data and the BDAV data is recorded in the recordable area 12.

In summary, as long as each of the data according to the reproduction standard and the data according to the recording standard is recorded on one optical disc 10, the optical disc 10 is a target for a reproduction operation by an information reproducing apparatus described later.

### (2) Basic Structure of the Information Reproducing Apparatus

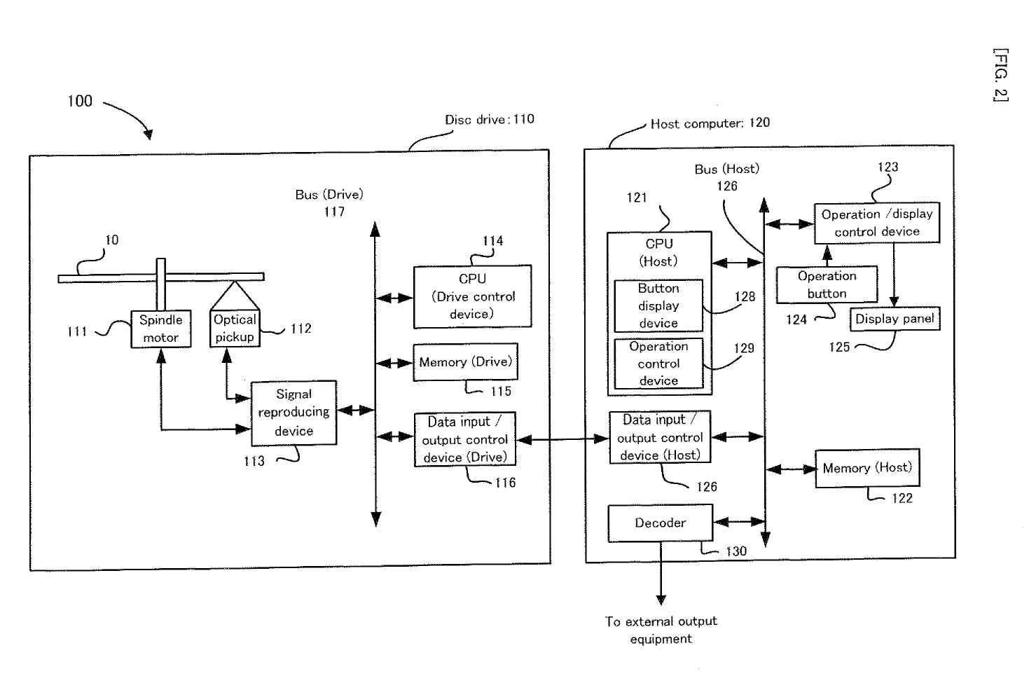

Next, with reference to FIG. 2, an explanation will be given on the basic structure of a reproducing apparatus 100 in this example. FIG. 2 is a block diagram conceptually showing the basic structure of the information reproducing apparatus 100 in the example.

As shown in FIG. 2, the information reproducing apparatus 100 is provided with a disc drive 110, on which the optical disc 10 is actually loaded and on which contents are reproduced; and a host computer 120 such as a personal computer, which controls the reproduction of the contents on the disc drive 110.

The disc drive 110 is provided with: the optical disc 10; a spindle motor 111; an optical pickup 112; a signal reproducing device 113; a CPU (drive control device) 114; a memory 115; a data input/output control device 116; and a bus 117. Moreover, the host computer 120 is provided with: a CPU 121; a memory 122; an operation/display control device 123; an operation button 124; a display panel 125; a data input/output control device 126; a bus 127; and a decoder 130.

The spindle motor 111 is intended to rotate and stop the optical disc 10, and operates upon accessing the optical disc. More specifically, the spindle motor 111 is constructed to rotate the optical disc 10 at a predetermined speed and stop it, under spindle servo from a not-illustrated servo unit or the like.

The optical pickup 112 is provided with a semiconductor laser device, a collimator lens, an objective lens, and the like, which are not illustrated, in order to perform the recording/reproduction with respect to the optical disc 10. More specifically, the optical pickup 112 irradiates the optical disc 10 with a light beam such as a laser beam, as reading light with a first power upon reproduction, and as writing light with a second power upon recording, with it modulated.

The signal reproducing device 113 constitutes one specific example of the “reproducing device” of the present invention with the decoder 130 described later. The signal reproducing device 113 controls the spindle motor 111 and the optical pickup 112 under the control of the CPU 114, to thereby perform the recording and the reproduction with respect to the optical disc 10. More specifically, the signal reproducing device 113 is provided with for example, a laser diode (LD) driver, a head amplifier, and so on. The LD driver generates, for example, a driving pulse and drives the semiconductor laser device located in the optical pickup 112. The head amplifier amplifies the output signal of the optical pickup 112, namely the reflected light of a light beam, and the head amplifier outputs the amplified signal.

The CPU (drive control device) 114 is connected to the signal reproducing device 113 and the memory 115 via the bus 117 and controls the entire disc drive 110 by giving an instruction to various controlled devices. In general, software for operating the CPU 114 or firmware is stored in the memory 115.

The memory 115 is used in the general data processing on the disc drive 110, including a buffer area for the record and reproduction data, an area used as an intermediate buffer when data is converted into the data that can be used on the signal recording device 113, and the like. Moreover, the memory 115 is provided with a Read Only Memory (ROM) area into which a program for performing an operation as a recording device, namely, a firmware program is stored; and a Random Access Memory (RAM) area in which the record data is temporarily stored or in which a parameter required for the operation of a firmware program or the like is stored; and the like.

The data input/output control device 116 controls the input/output of the data from the exterior with respect to the disc drive 110. A drive control command, issued from the external host computer 120 which is connected with the disc drive 110 through an interface such as a SCSI (Small Computer System Interface) and an ATAPI (AT Attachment Packet Interface), is transmitted to the CPU 114 through the data input/output control device 116. Moreover, the record data is exchanged with the host computer 120 through the data input/output control device 116 in the same manner.

The operation/display control device 123 receives an operation instruction and performs display with respect to the host computer 120, and transmits various instructions by the operation button 124 (e.g. an instruction to start the recording and an instruction to stop the recording) to the CPU 121. The CPU 121 transmits a control command to the disc drive 110 through the data input/output control device 126 on the basis of instruction information from the operation/display control device 123 and controls the entire disc drive 110. In the same manner, the CPU 121 can transmit a command to request the transmission of an operation state to the host computer 120, with respect to the disc drive 110. By this, the operation state of the disc drive 110 (e.g. a recording execution state and a recording stopping state) can be recognized, so that the CPU 121 can output the operation state of the disc drive 110 to the display panel 125 such as a fluorescent tube and a LCD, through the operation/display control device 123.

The decoder 130 constitutes one specific example of the “reproducing device” of the present invention with the aforementioned optical pickup 112. The decoder 130 decodes the data reproduced on the disc drive 110, to thereby generate video data and audio data. The generated video data and audio data are outputted to external output equipment such as a display and a speaker, and are displayed as video or outputted as audio.

The CPU 121 controls the entire host computer 120. In particular, the CPU 121 is provided with a button display device 128 and an operation control device 129, which are logically realized on the CPU 121 by a computer program which operates on the CPU 121.

The button display device 128 constitutes one specific example of the “displaying device” of the present invention. The button display device 128 is adapted to display a button unique to the information reproducing apparatus 100, on a menu screen for BDMV data recorded on the optical disc 10.

The operation control device 129 constitutes one specific example of the “controlling device” of the present invention. The operation control device 129 controls the disc drive 110 and the host computer 120 to display a menu screen for BDAV data if the button displayed by the operation of the button display device 128 is selected and activated by a user.

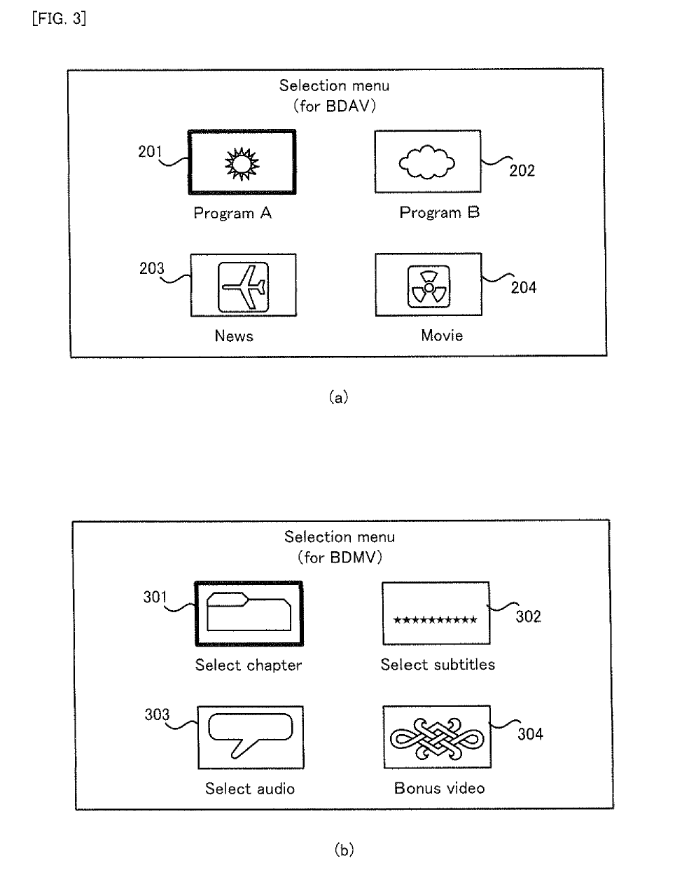

Incidentally, the detailed operations of the button display device 128 and the operation control device 129 will be detailed later (refer to FIG. 3).

The memory 122 is an internal storage apparatus used by the host computer 120. The memory 122 is provided with: ROM area into which a firmware program, such as a BIOS (Basic Input/Output System), is stored; a RAM area into which parameters required for an operating system and the operation of an application program or the like are stored; and the like.

### (3) Operation Example

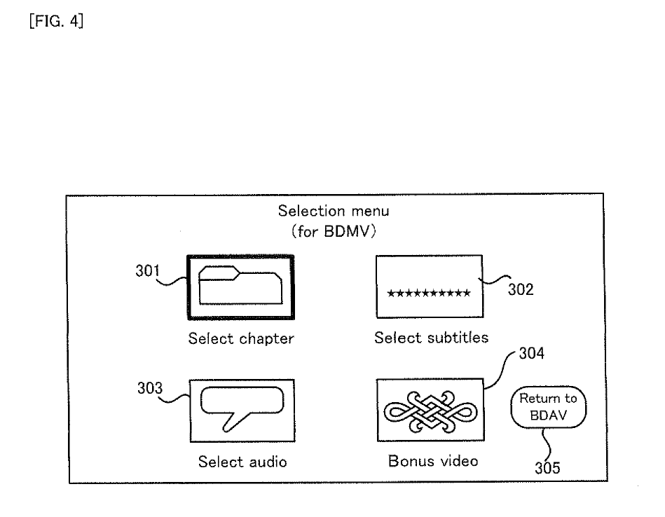

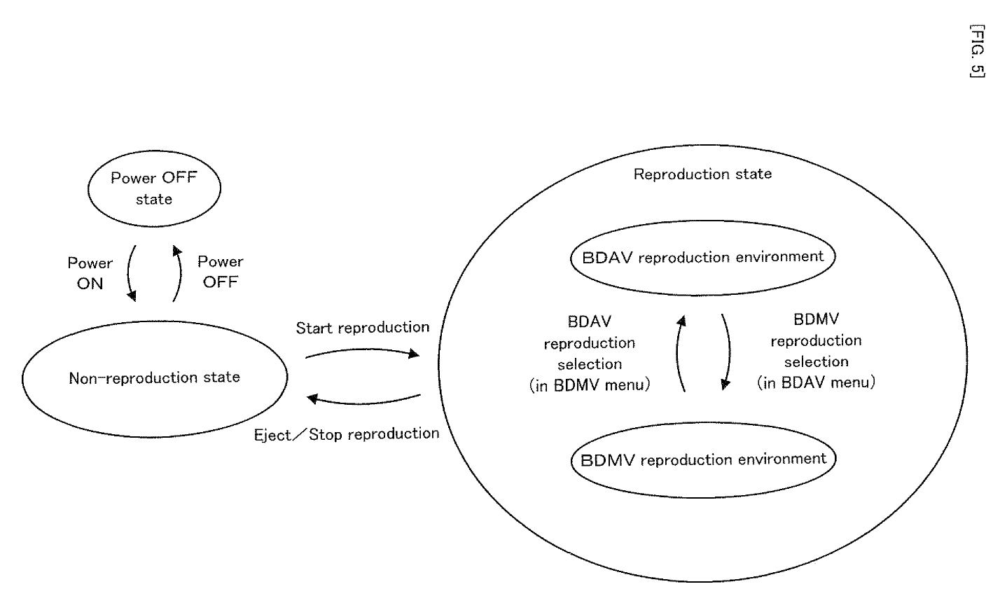

Next, with reference to FIG. 3 to FIG. 5, an explanation will be given on the operation example of the information reproducing apparatus 100 in the example. FIG. 3 are plan views conceptually showing the menu screen for BDMV data and the menu screen for BDAV data. FIG. 4 is a plan view conceptually showing the menu screen for BDMV data on which an additional button unique to the information reproducing apparatus 100 is displayed. FIG. 5 is a state transition diagram conceptually showing a transition aspect of a state of the information reproducing apparatus 100 in the example.

As shown in FIG. 3(a), if the BDAV data includes a TV program A, a TV program B, and a news program, the information reproducing apparatus 100 generates menu data for displaying the menu screen which allows the user to select which of the programs is to be reproduced, on the basis of the BDAV data. Specifically, the information reproducing apparatus 100 generates the menu data for displaying the menu screen including a button (or thumbnail image thereinafter the same shall apply)) 201 selected and activated by the user to reproduce the television program A, a button 202 selected and activated by the user to reproduce the TV program B, and a button 203 selected and activated by the user to reproduce the news program, on the basis of the BDAV data. In general, the menu screen based on the menu data is firstly displayed when the BDAV data is reproduced.

Moreover, since it is considered that the BDAV data is recorded (or written once) by the user onto the optical disc 10 as occasion demands, if the BDMV data is recorded on the optical disc 10, the BDAV data can be generated in view of the fact that the BDMV data is recorded on the optical disc 10. More specifically, as shown in FIG. 3(a), the menu screen for BDAV data, which displays a button 204 selected and activated by the user to reproduce the BDMV data, can be generated and displayed. If the button 204 is selected and activated by the user, the menu screen for BDMV data shown in FIG. 3(b) is displayed.

As shown in FIG. 3(b), if the BDMV data is a movie, the BDMV data includes the menu data for displaying the menu screen to perform operations related to the reproduction of the movie. Specifically, the BDMV includes the menu data for displaying the menu screen including a button 301 selected and activated by the user for chapter selection, a button 302 selected and activated by the user for subtitle selection, a button 303 selected and activated by the user for audio selection, and a button 304 selected and activated by the user for bonus (or extra) video reproduction.

Here, since the BDMV data is generated by being authorized in advance, the simultaneous recording of data other than the BDMV data onto the optical disc 10 is not considered. Therefore, the menu screen for BDMV data does not include any button to perform the operations related to the data other than the BDMV data. In other words, the menu screen for BDMV data includes only the button to perform the operations to be completed in the BDMV data. Thus, once the reproduction of the BDMV data is started, the BDAV data cannot be reproduced as long as the reproduction proceeds using the menu screen for BDMV data or in accordance with a reproduction sequence of the BDMV data or the like. That is, it is hardly possible to change to the reproduction of the BDAV data during the reproduction of the BDMV data.

Thus, in the information reproducing apparatus in the example, as shown in FIG. 4, an additional button 305 selected and activated by the user to display the menu screen for BDAV data (i.e. to return to the menu screen for BDAV data) is displayed on the menu screen for BDMV data, by the operation of the button display device 128. The additional button 305 constitutes one specific example of the “unique button” of the present invention. The additional button 305 is not a button included in the BDMV data but a button displayed on the menu screen for BDMV data by the function of the information reproducing apparatus 100 itself (i.e. by the function of the button display device 128).

If the additional button 305 is selected and activated by the user, the display of the menu screen for BDMV data is ended and the menu screen for BDAV data shown in FIG. 3(a) is displayed, under the control of the operation control device 129 in the CPU 121. That is, the menu data for displaying the menu screen for BDAV data buffered in the memory may be reproduced. Alternatively, the BDAV data may be obtained again from the optical disc 10, and the menu screen may be generated and displayed by the information reproducing apparatus 100.

Now, a more detailed explanation is given on the transition aspect of an operation state of the information reproducing apparatus 100 in which the additional button 305 is displayed on the menu screen for BDMV data. As shown in FIG. 5, if the power is changed to ON when the information reproducing apparatus 100 is in a power OFF state which indicates the state that the power is OFF the state of the information reproducing apparatus 100 transits to a non-reproduction state which indicates the state that the data is not reproduced. On the other hand, if the power is changed to OFF when the information reproducing apparatus 100 is in the non-reproduction state, the state of the information reproducing apparatus 100 transits to the power OFF state.

If an instruction to start the reproduction is given when the information reproducing apparatus 100 is in the non-reproduction state, the state of the information reproducing apparatus 100 transits to a reproduction state which indicates the state that the data is being reproduced. On the other hand, if an instruction to eject the optical disc 10 from the information reproducing apparatus 100 or an instruction to stop the reproduction are given when the information reproducing apparatus 100 is in the reproduction state, the state of the information reproducing apparatus 100 transits to the non-reproduction state.

In the example, when the information reproducing apparatus 100 transits to the reproduction state, the information reproducing apparatus 100 is firstly placed under a BDAV reproduction environment in which the BDAV data is reproduced. Thus, when the information reproducing apparatus 100 transits to the reproduction state, the menu screen for BDAV data as shown in FIG. 3(a) is firstly displayed. Therefore, using the menu screen, it is possible to reproduce the desired data included in the BDAV data. For example, in the case of the menu screen shown in FIG. 3(a), when the button 201 is selected and activated, the TV program A is reproduced. When the button 202 is selected and activated, the TV program B is reproduced. When the button 203 is selected and activated, the news program is reproduced.

Here, when the button 204 included in the menu screen of BDAV data is selected and activated, the information reproducing apparatus 100 is placed until a BDMV reproduction environment in which the BDMV data is reproduced, under the control of the operation control device 129. Thus, when the button 204 included in the menu screen for BDAV data is selected and activated, the menu screen for BDMV data as shown in FIG. 4 is firstly displayed. Therefore, using the menu screen, it is possible to reproduce a movie with desired subtitles and audio and from a desired chapter. Alternatively, using the menu screen, it is possible to reproduce bonus (or extra) video.

At this time, when the additional button 305 displayed on the menu screen for BDMV data by the operation of the button display device 128 is selected and activated, the information reproducing apparatus 100 is placed until the BDAV reproduction environment in which the BDAV data is reproduced, under the control of the operation control device 129. Thus, when the additional button 305 displayed on the menu screen for BDMV by the operation of the button display device 128 data is selected and activated, the menu screen for BDAV data is displayed. Therefore, it is possible to reproduce the desired data included in the BDAV data.

As described above, according to the information reproducing apparatus 100 in the example, even after the start of the reproduction of the BDMV data according to the BD-Video standard, which is the reproduction standard, it is possible to reproduce the BDAV data according to the BD-VR standard, which is the recording standard. In particular, in order to start the reproduction of the BDAV data after the reproduction of the BDMV data is started, it is unnecessary to eject the optical disc 10 from the information reproducing apparatus 100 to reset the operation of the information reproducing apparatus 100. That is, obviously, the user can relatively easily change the state of the information reproduction apparatus 100 from the state that the BDAV data is reproduced (i.e. the BDMV reproduction environment in FIG. 5) to the state that the BDMV data is reproduced (i.e. the BDMV reproduction environment in FIG. 5).

Moreover, the additional button 305, which is selected and activated by the user in order to change the state of the information reproducing apparatus 100 from the state that the BDMV data is reproduced to the state that the BDAV data is reproduced, is not a button included in the BDMV data but a button displayed on the menu screen for BDMV data by the function of the information reproducing apparatus 100 itself. Therefore, independently of an aspect of authoring for generating the BDMV data and the state of the BDMV data generated as a result of the authoring, it is possible to change the state of the information reproducing apparatus 100 from the sate that the BDMV data is reproduced to the state that the BDAV data is reproduced.

Incidentally, in addition to or instead of displaying the additional button 305, which is selected and activated by the user in order to change the state of the information reproducing apparatus 100 from the state that the BDMV data is reproduced to the state that the BDAV data is reproduced, on the menu screen for BDMV data, the menu screen for BDAV data may be displayed after a certain time of displaying the menu screen for BDMV data. That is, the state of the information reproducing apparatus 100 may be changed from the state that the BDMV data is reproduced to the state that the BDAV data is reproduced, after a certain time of displaying the menu screen for BDMV data. This allows the state of the information reproducing apparatus 100 to be changed from the state that the BDMV data is reproduced to the state that the BDAV data is reproduced, without forcing users to perform any special operation.

Moreover, the additional button 305, which is selected and activated by the user in order to change the state of the information reproducing apparatus 100 from the state that the BDMV data is reproduced to the state that the BDAV data is reproduced, may be displayed on the menu screen for BDMV data after a certain time of displaying the menu screen for BDMV data. That is, the additional button 305 may not be displayed until a certain time of displaying the menu screen for BDMV data. By this, users can visually recognize the entire menu screen for BDMV data at first. Thus, it is possible to properly prevent such a disadvantage that users miss or cannot visually recognize video at all because the additional button 305 is unintentionally superimposed on the video or the like in the menu screen for BDMV data.

Moreover, in the aforementioned example, when the state of the information reproducing apparatus 100 is changed from the state that the BDAV data is reproduced to the state that the BDMV data is reproduced, the button 204 is displayed, selected, and activated to be included in the menu screen for BDAV data generated by the information reproducing apparatus 100.

### (4) Specific Display Aspect of Displaying the Button

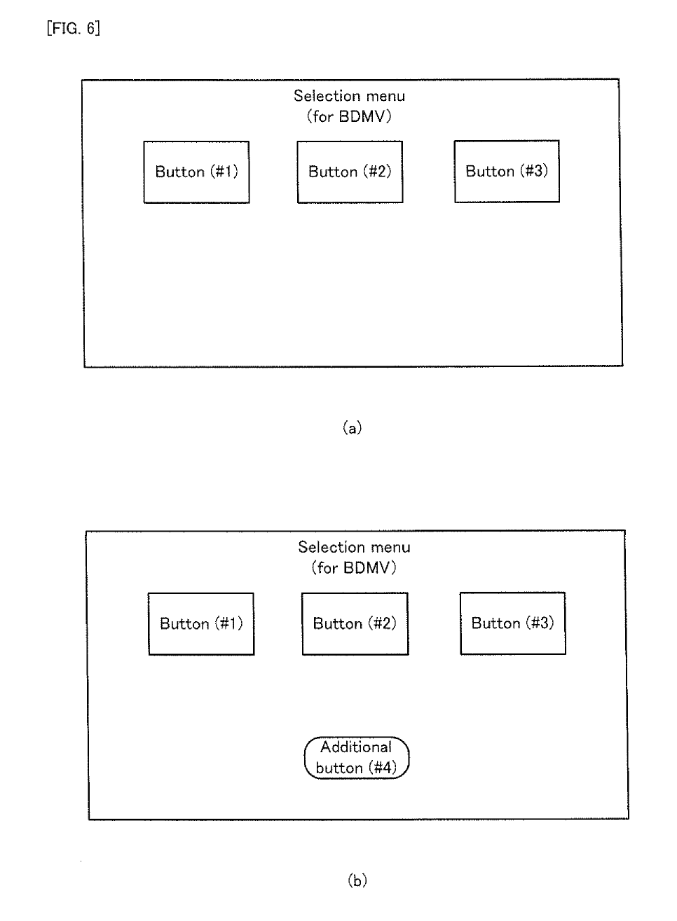

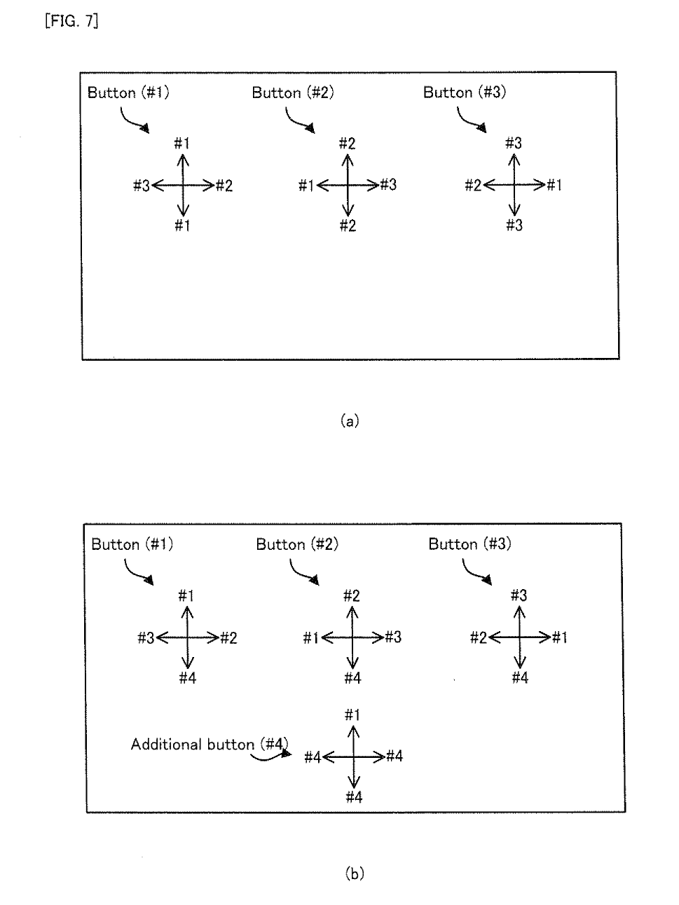

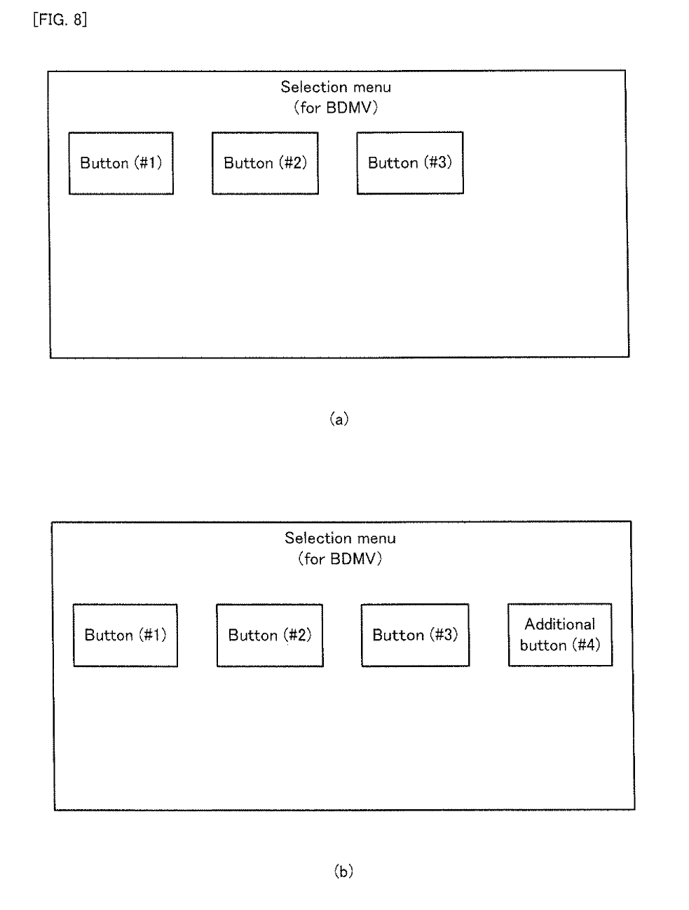

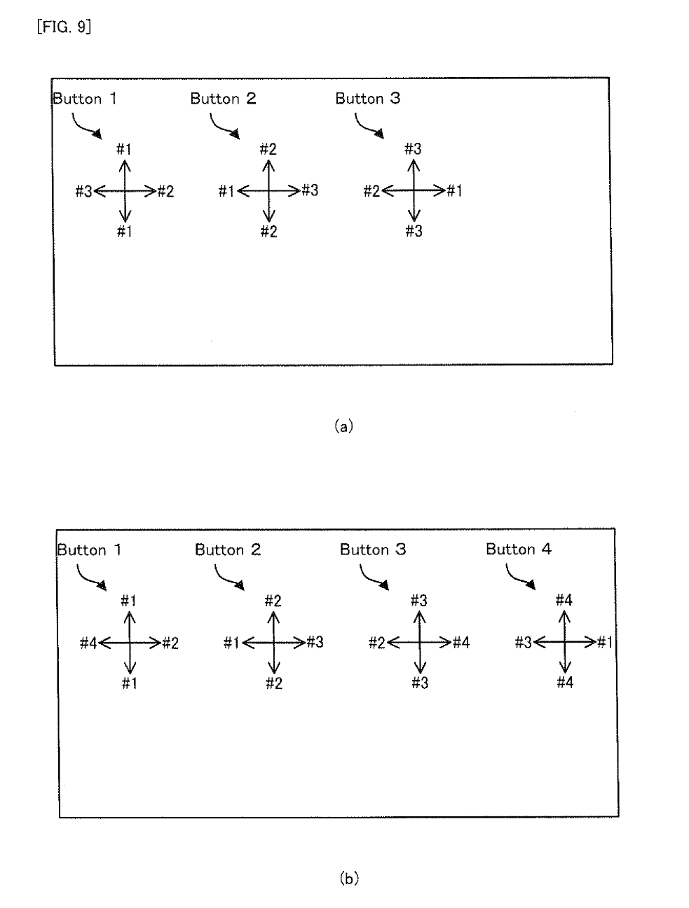

Next, with reference to FIG. 6 to FIG. 9, an explanation will be given on the specific display aspect of displaying the addition button 305, displayed by the information reproducing apparatus 100 in the example. FIG. 6 are plan views conceptually showing a first menu screen for BDMV data before and after the additional button 305 is displayed. FIG. 7 are plan views conceptually showing a transition relation when each of the buttons is selected on the first menu screen before and after the additional button 305 is displayed. FIG. 8 are plan views conceptually showing a second menu screen for BDMV data before and after the additional button 305 is displayed. FIG. 9 are plan views conceptually showing a transition relation when each of the buttons is selected on the second menu screen before and after the additional button 305 is displayed.

As shown in FIG. 6(a), it is assumed that the menu screen for BDMV data before the additional button 305 is displayed includes three buttons: a button (#1), a button (#2), and a button (#3). Incidentally, the signs of “#1”, “#2”, and “#3” denote the identification numbers of buttons.

When a selection is made on the three buttons included in the menu screen for BDMV data before the additional button 305 is displayed, i.e. the button (#1), the button (#2), and the button (#3), a selection target transits as shown in FIG. 7(a).

Specifically, it is assumed that the button (#1) is selected. At this time, when the upper button of an arrow key provided for the operation button 124 is pressed, the selection-target button is still the button (#1). When the right button of the arrow key provided for the operation button 124 is pressed, the selection-target button transits to the button (#2). When the lower button of the arrow key provided for the operation button 124 is pressed, the selection-target button is still the button (#1). When the left button of the arrow key provided for the operation button 124 is pressed, the selection-target button transits to the button (#3).

In the same manner, it is assumed that the button (#2) is selected. At this time, when the upper button of the arrow key provided for the operation button 124 is pressed, the selection-target button is still the button (#2). When the right button of the arrow key provided for the operation button 124 is pressed, the selection-target button transits to the button (#3). When the lower button of the arrow key provided for the operation button 124 is pressed, the selection-target button is still the button (#2). When the left button of the arrow key provided for the operation button 124 is pressed, the selection-target button transits to the button (#1).

In the same manner, it is assumed that the button (#3) is selected. At this time, when the upper button of the arrow key provided for the operation button 124 is pressed, the selection-target button is still the button (#3). When the right button of the arrow key provided for the operation button 124 is pressed, the selection-target button transits to the button (#1). When the lower button of the arrow key provided for the operation button 124 is pressed, the selection-target button is still the button (#3). When the left button of the arrow key provided for the operation button 124 is pressed, the selection-target button transits to the button (#2).

When the additional button 305 is displayed on such a menu screen, the following conditions are preferably considered. Specifically, firstly, the additional button 305 is preferably displayed at a position at which it does not overlap the existing button (#1), button (#2), and button (#3). Moreover, in view of the arrangement of the existing button (#1), button (#2), and button (#3), the additional button 305 is preferably displayed at a position at which it suits for or does not unreasonably lose the arrangement. Moreover, in view of the size, shape, or the like of the existing button (#1), button (#2), and button (#3), the additional button 305 is preferably displayed in such a size and shape that it suits for or is not unreasonably too different from the size, shape, or the like of the existing buttons.

In view of these, for example, the additional button 305 is disposed as shown in FIG. 6(b). Specifically, the additional button 305 is displayed on the lower side of the button (#1), the button (#2), and the button (#3) on which the additional button 305 does not overlap the buttons (#1), the button (#2), and the button (#3). Incidentally, the identification number of the additional button 305 is shown by “#4”.

By that the additional button 305 is displayed, the selection target transits as shown in FIG. 7(b) when a selection is made on the four buttons included in the menu screen for BDMV data: the button (#1), the button (#2), the button (#3), and the additional button 305.

Specifically, it is assumed that the button (#1) is selected. At this time, when the upper button of the arrow key provided for the operation button 124 is pressed, the selection-target button is still the button (#1). When the right button of the arrow key provided for the operation button 124 is pressed, the selection-target button transits to the button (#2). When the lower button of the arrow key provided for the operation button 124 is pressed, the selection-target button transits to the button (#4). When the left button of the arrow key provided for the operation button 124 is pressed, the selection-target button transits to the button (#3). That is, the transition relation when the lower button of the arrow key provided for the operation button 124 is pressed is changed.

In the same manner, it is assumed that the button (#2) is selected. At this time, when the upper button of the arrow key provided for the operation button 124 is pressed, the selection-target button is still the button (#2). When the right button of the arrow key provided for the operation button 124 is pressed, the selection-target button transits to the button (#3), When the lower button of the arrow key provided for the operation button 124 is pressed, the selection-target button transits to the button (#4). When the left button of the arrow key provided for the operation button 124 is pressed, the selection-target button transits to the button (#1). That is, the transition relation when the lower button of the arrow key provided for the operation button 124 is pressed is changed.

In the same manner, it is assumed that the button (#3) is selected. At this time, when the upper button of the arrow key provided for the operation button 124 is pressed, the selection-target button is still the button (#3). When the right button of the arrow key provided for the operation button 124 is pressed, the selection-target button transits to the button (#1). When the lower button of the arrow key provided for the operation button 124 is pressed, the selection-target button transits to the button (#4). When the left button of the arrow key provided for the operation button 124 is pressed, the selection-target button transits to the button (#2). That is, the transition relation when the lower button of the arrow key provided for the operation button 124 is pressed is changed.

Moreover, it is assumed that the button (#4) is selected. At this time, when the upper button of the arrow key provided for the operation button 124 is pressed, the selection-target button transits to the button (#1). When the right button of the arrow key provided for the operation button 124 is pressed, the selection-target button is still the button (#4). When the lower button of the arrow key provided for the operation button 124 is pressed, the selection-target button is still the button (#4). When the left button of the arrow key provided for the operation button 124 is pressed, the selection-target button is still the button (#4).

By this, each button can be preferably selected by operating the operation button 124 even after the additional button 305 is displayed on the menu screen for BDMV data.

Incidentally, in the transition relation when each button is selected, data which indicates the transition relation of default included in the BDMV data is preferably stored in the memory 122 or the like, and the data stored in the memory 122 is preferably updated in accordance with the display of the additional button 305.

The button arrangement in another aspect will be explained.

As shown in FIG. 8(a), it is assumed that the menu screen for BDMV data before the additional button 305 is displayed includes the three buttons: the button (#1), the button (#2), and the button (#3).

When a selection is made on the three buttons included in the menu screen for BDMV data before the additional button 305 is displayed, i.e. the button (#1), the button (#2), and the button (#3), the selection target transits as shown in FIG. 9(a).

Specifically, it is assumed that the button (#1) is selected. At this time, when the upper button of the arrow key provided for the operation button 124 is pressed, the selection-target button is still the button (#1). When the right button of the arrow key provided for the operation button 124 is pressed, the selection-target button transits to the button (#2). When the lower button of the arrow key provided for the operation button 124 is pressed, the selection-target button is still the button (#1). When the left button of the arrow key provided for the operation button 124 is pressed, the selection-target button transits to the button (#3).

In the same manner, it is assumed that the button (#2) is selected. At this time, when the upper button of the arrow key provided for the operation button 124 is pressed, the selection-target button is still the button (#2). When the right button of the arrow key provided for the operation button 124 is pressed, the selection-target button transits to the button (#3). When the lower button of the arrow key provided for the operation button 124 is pressed, the selection-target button is still the button (#2). When the left button of the arrow key provided for the operation button 124 is pressed, the selection-target button transits to the button (#1).

In the same manner, it is assumed that the button (#3) is selected. At this time, when the upper button of the arrow key provided for the operation button 124 is pressed, the selection-target button is still the button (#3). When the right button of the arrow key provided for the operation button 124 is pressed, the selection-target button transits to the button (#1). When the lower button of the arrow key provided for the operation button 124 is pressed, the selection-target button is still the button (#3). When the left button of the arrow key provided for the operation button 124 is pressed, the selection-target button transits to the button (#2).

When the additional button 305 is displayed on such a menu screen, the additional button 305 is disposed, for example, as shown in FIG. 8(b) in view of the aforementioned conditions. Specifically, the additional button 305 with the same size as the button (#1), the button (#2), and the button (#3) is displayed such that the additional button 305 is newly added to the arrangement of the button (#1), the button (#2), and the button (#3) without disarrangement. Incidentally, the identification number of the additional button 305 is shown by “#4”.

By that the additional button 305 is displayed, the selection target transits as shown in FIG. 9(b) when a selection is made on the four buttons included in the menu screen for BDMV data: the button (#1), the button (#2), the button (#3), and the additional button 305.

Specifically, it is assumed that the button (#1) is selected. At this time, when the upper button of the arrow key provided for the operation button 124 is pressed, the selection-target button is still the button (#1). When the right button of the arrow key provided for the operation button 124 is pressed, the selection-target button transits to the button (#2). When the lower button of the arrow key provided for the operation button 124 is pressed, the selection-target button is still the button (#1). When the left button of the arrow key provided for the operation button 124 is pressed, the selection-target button transits to the button (#4). That is, the transition relation when the left button of the arrow key provided for the operation button 124 is pressed is changed.

In the same manner, it is assumed that the button (#2) is selected. At this time, when the upper button of the arrow key provided for the operation button 124 is pressed, the selection-target button is still the button (#2). When the right button of the arrow key provided for the operation button 124 is pressed, the selection-target button transits to the button (#3). When the lower button of the arrow key provided for the operation button 124 is pressed, the selection-target button is still the button (#2). When the left button of the arrow key provided for the operation button 124 is pressed, the selection-target button transits to the button (#1). That is, the transition relation is not changed for the button (#2).

In the same manner, it is assumed that the button (#3) is selected. At this time, when the upper button of the arrow key provided for the operation button 124 is pressed, the selection-target button is still the button (#3). When the right button of the arrow key provided for the operation button 124 is pressed, the selection-target button transits to the button (#4). When the lower button of the arrow key provided for the operation button 124 is pressed, the selection-target button transits to the button (#3). When the left button of the arrow key provided for the operation button 124 is pressed, the selection-target button transits to the button (#2). That is, the transition relation when the right button of the arrow key provided for the operation button 124 is pressed is changed.

Moreover, it is assumed that the button (#4) is selected. At this time, when the upper button of the arrow key provided for the operation button 124 is pressed, the selection-target button is still the button (#4). When the right button of the arrow key provided for the operation button 124 is pressed, the selection-target button transits to the button (#1). When the lower button of the arrow key provided for the operation button 124 is pressed, the selection-target button is still the button (#4). When the left button of the arrow key provided for the operation button 124 is pressed, the selection-target button transits to the button (#3).

Incidentally, the aforementioned conditions are not necessarily considered. That is, it is only necessary that at least the additional button 305 is displayed on the menu screen for BDMV data, from the viewpoint of receiving the advantageous effect of changing the state of the information reproducing apparatus 100 from the state that the BDMV data is reproduced to the state that the BDAV data is reproduced.

### (5) Modified Example

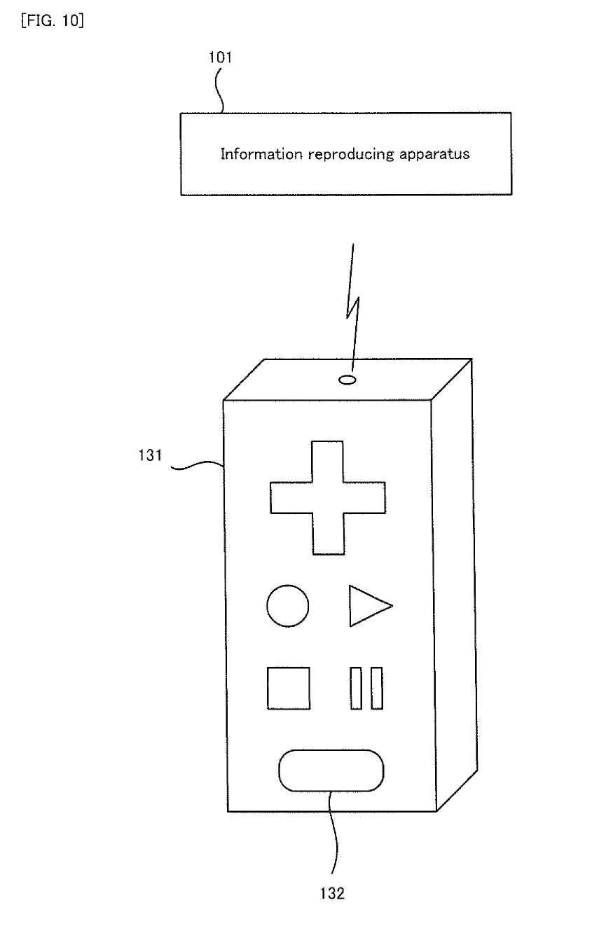

Next, with reference to FIG. 10, an explanation will be given on a modified example of the information reproducing apparatus 100 in the example. FIG. 10 is a perspective view conceptually showing a remote controller 131 provided for an information reproducing apparatus 101 in the modified example.

As shown in FIG. 10, the information reproducing apparatus 101 in the modified example is provided with the remote controller 131 equipped with a state transition operation button 132, instead of the aforementioned button display device 128. The state transition operation button 132 or the remote controller 131 constitutes one specific example of the “inputting device” of the present invention.

In the modified example, when the state transition operation button 132 is pressed by a user when the BD data is reproduced (or the menu screen for BDMV data is displayed), a signal indicating the fact is transmitted to the information reproducing apparatus 101 from the remote controller 131 with infrared rays or the like. As a result, the operation control device 129, as in the aforementioned information reproducing apparatus 100, changes the state of the information reproducing apparatus 101 from the state that the BDMV data is reproduced to the state that the BDAV data is reproduced. This allows the information reproducing apparatus 101 in the modified example to properly receive the aforementioned various benefits.

Incidentally, by combining the remote controller 131 with the aforementioned information reproducing apparatus 100, the operation by the state transition operation button 132 equipped with the remote controller 131 may be performed while the additional button 305 is displayed on the menu screen for BDMV data.

Incidentally, in the aforementioned example, the optical disc 10 is explained as one example of the information recording medium, and the player related to the optical disc 10 is explained as one example of the information reproducing apparatus. The present invention, however, is not limited to the optical disc and the player thereof, and can be applied to other various information recording media which support high-density recording or a high transfer rate, and players thereof.

The present invention is not limited to the aforementioned example, but various changes may be made, if desired, without departing from the essence or spirit of the invention which can be read from the claims and the entire specification. An information reproducing apparatus and method, and a computer program, all of which involve such changes, are also intended to be within the technical scope of the present invention.

1. An information reproducing apparatus for reproducing an information recording medium on which each of first data according to a reproduction standard and second data according to a recording standard is recorded,
said information reproducing apparatus comprising:
a reproducing device for reproducing the first data or the second data;
a controlling device for controlling said reproducing device such that said reproducing device starts the reproduction of the second data after stopping the reproduction of the first data if said reproducing device reproduces the first data; and
a displaying device for displaying a unique button unique to said information reproducing apparatus with the unique button superimposed on the first data if said reproducing device reproduces the first data,
said controlling device controlling said reproducing device such that said reproducing device starts the reproduction of the second data if the unique button is selected and activated when said reproducing device reproduces the first data.

2. The information reproducing apparatus according to claim 1, wherein said controlling device controls said reproducing device such that said reproducing device starts reproduction of a menu included in the second data after stopping the reproduction of the first data if said reproducing device reproduces the first data.

3. The information reproducing apparatus according to claim 1, wherein said controlling device controls said reproducing device such that said reproducing device starts the reproduction of the second data after stopping the reproduction of the first data if said reproducing device reproduces a menu included in the first data.

4. (canceled)

5. The information reproducing apparatus according to claim 1, wherein said displaying device displays the unique button with the unique button superimposed on a menu included in the first data.

6. The information reproducing apparatus according to claim 1, wherein said displaying device displays the unique button at a different position from a position at which a first data button included in the first data is displayed.

7. The information reproducing apparatus according to claim 1, wherein said displaying device displays the unique button such that a first data button included in the first data and the unique button are disposed in a substantially uniform manner.

8. The information reproducing apparatus according to claim 1, wherein said displaying device displays the unique button having a size corresponding to a first data button included in the first data.

9. The information reproducing apparatus according to claim 1, wherein said displaying device displays the unique button while adding a transition relation when selecting each of the unique button and the first data button included in the first data to a transition relation when selecting a first data button included in the first data.

10. The information reproducing apparatus according to claim 1, wherein said displaying device displays the unique button after a certain time has elapsed since said reproducing device started the reproduction of the first data.

11. The information reproducing apparatus according to claim 1, further comprising an inputting device for giving said controlling device an input instruction to control said reproducing device such that said reproducing device starts the reproduction of the second data,
said controlling device controlling said reproducing device such that said reproducing device starts the reproduction of the second data if the input instruction is given by said inputting device when said reproducing device reproduces the first data.

12. The information reproducing apparatus according to claim 1, wherein said controlling device controls said reproducing device such that said reproducing device starts the reproduction of the second data after stopping the reproduction of the first data after a certain time has elapsed since said reproducing device started the reproduction of the first data.

13. An information reproducing method of reproducing an information recording medium on which each of first data according to a reproduction format and second data according to a recording format is recorded,
said information reproducing method comprising:
a reproducing process of reproducing the first data or the second data;
a controlling process of controlling said reproducing process such that said reproducing device starts the reproduction of the second data after stopping the reproduction of the first data if said reproducing process reproduces the first data; and
a displaying process of displaying a unique button unique to an information reproducing apparatus with the unique button superimposed on the first data if said reproducing process reproduces the first data,
said controlling process controlling said reproducing process such that said reproducing process starts the reproduction of the second data if the unique button is selected and activated when said reproducing process reproduces the first data.

14. A computer readable recording medium recording thereon a computer program for reproduction control and for controlling a computer provided for an information reproducing apparatus for reproducing an information recording medium on which each of first data according to a reproduction standard and second data according to a recording standard is recorded, said information reproducing apparatus comprising: a reproducing device for reproducing the first data or the second data; a controlling device for controlling said reproducing device such that said reproducing device starts the reproduction of the second data after stopping the reproduction of the first data if said reproducing device reproduces the first data; and a displaying device for displaying a unique button unique to said information reproducing apparatus with the unique button superimposed on the first data if said reproducing device reproduces the first data, said controlling device controlling said reproducing device such that said reproducing device starts the reproduction of the second data if the unique button is selected and activated when said reproducing device reproduces the first data,
said computer program making the computer function as at least one portion of said reproducing device, said controlling device and said displaying device.
